(19) United States
(12) Patent Application Publication
(10) Pub. No.: US 2024/0092951 A1
(43) Pub. Date: Mar. 21, 2024

(54) PHOTO-CURABLE COMPOSITION, CURED PRODUCT THEREOF, AND DISPLAY DEVICE COMPRISING SAME

(71) Applicant: DONGJIN SEMICHEM CO., LTD., Incheon (KR)

(72) Inventors: Tai Hoon YEO, Hwaseong-si (KR); Hyoc Min YOUN, Hwaseong-si (KR); Sang Hoon LEE, Hwaseong-si (KR); Jong Hyuk PARK, Hwaseong-si (KR); Jea Young LEE, Hwaseong-si (KR); Ja Young KIM, Hwaseong-si (KR)

(21) Appl. No.: 18/502,573

(22) Filed: Nov. 6, 2023

Related U.S. Application Data
(63) Continuation of application No. PCT/KR2022/006459, filed on May 6, 2022.

(30) Foreign Application Priority Data
May 6, 2021 (KR) 10-2021-0058721
May 4, 2022 (KR) 10-2022-0055301

(51) Int. Cl. C08F 210/06; C08F 210/02; C08F 220/18; C08F 220/30; G02B 1/04

(52) U.S. Cl. CPC C08F 210/06; C08F 210/02; C08F 220/1806; C08F 220/301; G02B 1/04; C08F 2800/20

(57) ABSTRACT

The present disclosure relates to a photo-curable composition, a cured product thereof, and an optical member and a display device comprising same. The photo-curable composition has excellent low refractive index, light transmittance, and low haze characteristics by comprising a first olefinic monomer containing fluorine, a second olefinic monomer having an absolute viscosity of 7 cP or less at 25° C., a photo-polymerization initiator, and an amine compound.

### CROSS-REFERENCE TO RELATED APPLICATIONS

The present application is a Continuation of International Application No. PCT/KR2022/006459 filed May 6, 2022, which claims priority from Korean Application Nos. 10-2022-0055301 filed May 4, 2022 and 10-2021-0058721 filed May 6, 2021. The aforementioned applications are incorporated herein by reference in their entireties.

### TECHNICAL FIELD

The present disclosure relates to a photocurable composition capable of forming an optical member exhibiting improved optical properties including excellent low refractive index, high transmittance, and low haze, and an optical member and a display device including the same.

### RELATED ART

Needs to improve light efficiency in organic light emitting diodes (OLEDs), image sensors, and the like are increasing. As a technology that is absolutely necessary for improving OLED lifespan and increasing battery efficiency, research and development on refractive index control optical films has recently been actively conducted.

The theoretical lower limit value of the range of low refractive index controllable by organic compounds is known to be about low to mid 1.4 s. When hollow silica is mixed, the refractive index is lowered, but there are problems of transmittance, haze, and lowering of upper and lower film adhesive forces due to compatibility problems with organic compounds. In addition, since the viscosity of the composition increases so that problems such as a decrease in inkjet processability occur, it has many technical restrictions.

Due to these various problems of the conventional art, development of a technology capable of forming an optical film that controls the decrease in transmittance and increase in haze while exhibiting low refractive index characteristics, and exhibits excellent adhesive force and heat resistance has been continuously requested.

### SUMMARY

In order to solve the above problems, an object of the present disclosure is to provide a photocurable composition capable of forming an optical film which controls the decrease in transmittance and increase in haze while exhibiting low refractive index characteristics, and exhibits excellent adhesive force and heat resistance.

Another object of the present disclosure is to provide a cured product of the photocurable composition.

Another object of the present disclosure is to provide an optical member including the cured product.

Another object of the present disclosure is to provide a display device including the optical member.

In order to achieve the above objects, a photocurable composition according to an embodiment of the present disclosure includes a first olefinic monomer containing fluorine, a second olefinic monomer having an absolute viscosity of 7 cP or less at 25° C., a photopolymerization initiator, and an amine compound, and includes 1 to 20 parts by weight of the photopolymerization initiator and 1 to 15 parts by weight of the amine compound based on 100 parts by weight of the total weight of the first olefinic monomer and the second olefinic monomer.

A cured product according to another embodiment of the present disclosure is such product in which the photocurable composition is cured.

A display device according to another embodiment of the present disclosure includes the cured product.

The photocurable composition according to the present disclosure exhibits high transmittance characteristics, low haze characteristics, excellent adhesive force, and excellent heat resistance while exhibiting low refractive index characteristics.

In particular, the photocurable composition according to the present disclosure has a refractive index of 1.48 or less based on light having a wavelength of 450 nm so that an optical member having excellent optical properties can be implemented, and a high-resolution display device can be implemented.

### DETAILED DESCRIPTION

The terms or words used in this specification and claims should not be construed as being limited to ordinary or dictionary meanings, and they should be interpreted as meanings and concepts consistent with the technical ideas of the present disclosure based on the principle that the inventor can appropriately define the concepts of the terms in order to explain his or her invention in the best way.

Therefore, since the configurations shown in Examples and Preparation Example described in this specification are merely exemplary embodiments of the present disclosure, and do not represent all of the technical ideas of the present disclosure, it should be understood that there may be various equivalents and modifications that can be substituted for them at the time of this application.

Hereinafter, the Examples of the present disclosure will be described in detail so that those skilled in the art to which the present disclosure pertains can easily implement the present disclosure. However, the present disclosure can be implemented in many different forms and is not limited to the Preparation Example and Examples described herein.

As used herein, the term “etheric oxygen atom” means an oxygen atom that forms an ether bond (—O—) between carbon-carbon atoms.

As used herein, the term “fluoroalkyl(ene) group” means a group in which some or all of the hydrogen atoms of the alkyl(ene) group are substituted with fluorine atoms, and the term “perfluoroalkyl(ene) group” means a group in which all of the hydrogen atoms of an alkyl(ene) group are substituted with fluorine atoms. Accordingly, a “fluoroalkyl(ene) group” includes a “perfluoroalkyl(ene) group”.

As used herein, the term “organic group” means a group having one or more carbon atoms.

A photocurable composition according to an embodiment of the present disclosure includes a first olefinic monomer containing fluorine, a second olefinic monomer having an absolute viscosity of 7 cP or less at 25° C., a photopolymerization initiator, and an amine compound. In some embodiments, the photocurable composition includes 1 to 20 parts by weight of the photopolymerization initiator and 1 to 20 parts by weight of the amine compound based on 100 parts by weight of the total weight of the first and the second olefinic monomers.

In order for the photocurable composition to have a refractive index of 1.48 or less with respect to the light of a wavelength of 450 nm, the homopolymer of the first olefinic monomer preferably has a refractive index of 1.46 or less with respect to the light of a wavelength of 450 nm. The first olefinic monomer contains fluorine so that it may play a role in controlling an increase in refractive index by the second olefinic monomer, a photopolymerization initiator, and an amine compound in the photocurable composition.

In the photocurable composition of the present disclosure, the first olefinic monomer having an absolute viscosity of 50 cP or less at 25° C. is preferred in order to realize excellent coating processability along with excellent optical properties. When the absolute viscosity of the first olefinic monomer exceeds 50 cP at 25° C., a problem that coating processability of the photocurable composition is greatly reduced may occur.

The first olefinic monomer may include a structure of General Formula 1 below.

(A)ₒ-(Z)ᵣ-(CFX)ₙ(R_{f})ₘ-(Z)ₛ-(A)ₚ [General Formula 1]
in General Formula 1,
A is a curable functional group,
o and p are each independently an integer of 0 or 1 (provided that o and p are not 0 at the same time),
r and s are each independently an integer of 0 or 1 (provided that r and s are not 0 at the same time),
Z is a divalent organic group having 1 to 10 carbon atoms,
X is a hydrogen atom, a fluorine atom, or a trifluoromethyl(ene) group,
n is an integer of 0 to 20,
R_{f} is hydrogen, a fluoroalkyl group or fluoroalkylene group having 1 to 20 carbon atoms which may have an etheric oxygen atom, —OF group, or a fluorine atom,
m is an integer of 0 to 2, and
n and m are not 0 at the same time.

The curable functional group of A in General Formula 1 above may be, for example, a (meth)acrylate group.

The divalent organic group having 1 to 10 carbon atoms of Z in General Formula 1 above may be, for example, an alkylene group having 1 to 10 carbon atoms.

The first olefinic monomer may contain a fluoro group such as a fluoroalkyl(ene) group, for example, a perfluoro group such as a perfluoroalkyl(ene) group. For example, in General Formula 1 above, m exceeds 0 and R_{f} may be a fluoroalkyl group or fluoroalkylene group having 1 to 20 carbon atoms which may have an etheric oxygen atom. It may effectively implement low refractive index characteristics due to fluorine by including a fluoro group in this way.

Preferably, the first olefinic monomer may include both a diacrylate-based monomer and a monoacrylate-based monomer. For example, the first olefinic monomer may be a monoacrylate-based monomer in which A is a (meth)acrylate group, o is 0, and p is 1, or o is 1 and p is 0 in General Formula 1 above, and may be, for another example, a diacrylate-based monomer in which A is a (meth)acrylate group and both o and p are 1 in General Formula 1. Although it may be preferable to use a diacrylate-based monomer in terms of curability, since coating processability may be reduced, a suitable ratio of monoacrylate may be mixed and used. For example, when these are mixed, the mixing ratio may be appropriately adjusted to a viscosity level of about 50 cP or less, but in terms of curability, the amount of the diacrylate-based monomer may be at least excessive compared to the amount of the monoacrylate-based monomer.

The first olefinic monomer may specifically include one or more of the monomers represented by Chemical Formulas 1 to 17 below, but is not limited thereto.

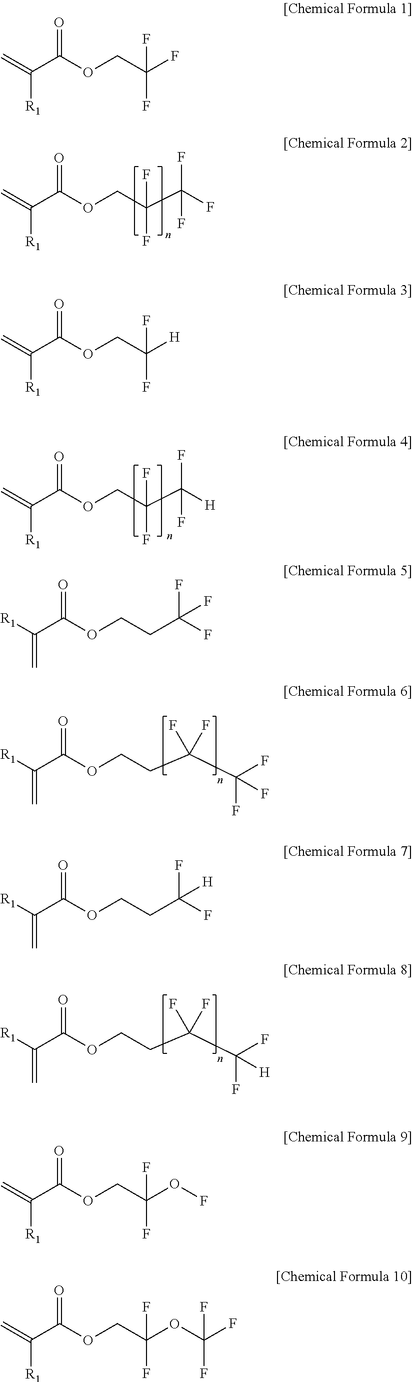

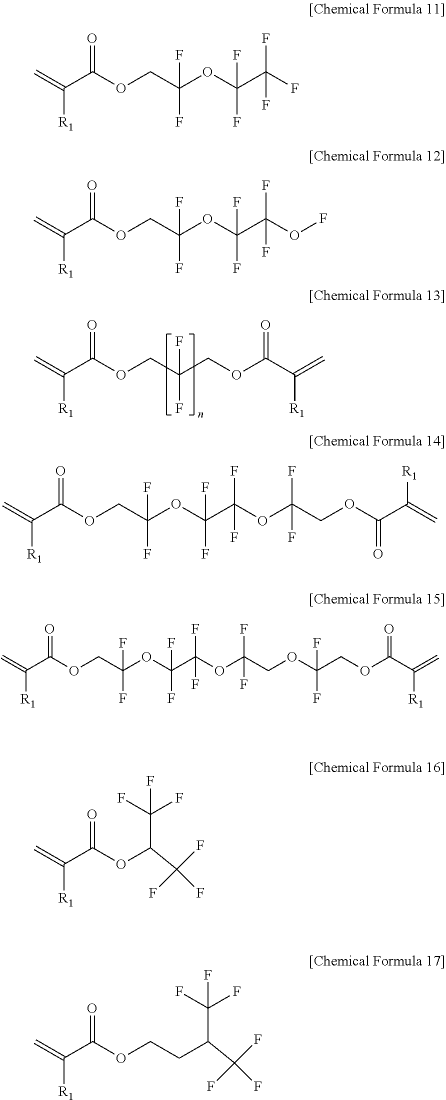

in Chemical Formulas 2, 4, 5, 8, and 13, n's are each independently an integer of 1 to 10, and in Chemical Formulas 1 to 17, R₁'s are each independently hydrogen or a methyl group.

The second olefinic monomer may include one which has low viscosity characteristics of 7 cP or less in absolute viscosity at 25° C. and thus improves the coatability and processability of the photocurable composition of the present disclosure, and which, along with this, has a refractive index of the homopolymer of 1.56 or less with respect to the light of 450 nm wavelength. The first olefinic monomer may contain fluorine and thus improve the optical properties of the composition excellently, but when used alone, since the viscosity of the composition is high, coatability and processability may be reduced, rendering the use of the second olefinic monomer having a low viscosity with the first olefinic monomer advantageous.

Meanwhile, the first olefinic monomer and the second olefinic monomer may be contained in the composition at a weight ratio of 50:50 to 90:10. If the ratio of the first olefinic monomer is increased to be higher than the above-mentioned weight ratio range, the viscosity of the composition may be increased too high so that a problem of a decrease in slit coatability may occur, and if the ratio of the second olefinic monomer is increased to be higher than the above-mentioned weight ratio range, problems in which optical properties such as refractive index, transmittance, and haze of the composition are deteriorated may occur.

The second olefinic monomer may be, for example, one or more of benzyl (meth)acrylate, isodecyl (meth)acrylate, lauryl (meth)acrylate, ethoxy ethyl (meth)acrylate, vinyloxyethoxyethyl (meth)acrylate, dicyclopentenyl (meth)acrylate, phenoxy ethyl (meth)acrylate, phenoxy benzyl (meth)acrylate, 1,6-hexanediol di(meth)acrylate, triethylene glycol di(meth)acrylate, and dicyclopentanyl (meth)acrylate, but is not limited to the above examples.

The photopolymerization initiator is contained in an amount of 1 to 20 parts by weight based on 100 parts by weight of the total weight of the first and the second olefinic monomers. When the photopolymerization initiator is contained less than the above-described range, the photopolymerization reaction rate is very slow so that a problem that processability is greatly deteriorated may occur. When the photopolymerization initiator is contained in a large amount compared to the above-described range, since it is not dissolved, particles may be generated in the solution, and may be a cause of deteriorating the storage stability.

The photopolymerization initiator may be, for example, one or more of triazine-based, benzoin-based, benzophenone-based, imidazole-based, xanthone-based, oxime ester-based, and acetophenone-based compounds, but is not limited to the above examples.

The amine compound is basically a material containing an amine group, and may further include a curable functional group or further include an aromatic structure that may have an etheric oxygen atom or a carbonyl group, and may further include both the curable functional group and the aromatic structure.

In the amine compound, the curable functional group may be, for example, a (meth)acrylate group.

The amine compound may act as a synergist in the photocurable composition to enable optical properties to be excellently maintained by improving the curing degree of the olefinic monomer. Further, since it prevents lowering of the radical reaction caused by oxygen in the air, it enables curing in an exposure environment with air other than nitrogen. Due to this, the facility investment cost can be drastically reduced.

The amine compound is contained in an amount of 1 to 20 parts by weight based on 100 parts by weight of the total weight of the first and the second olefinic monomers. When the amine compound is contained in the photocurable composition of the present disclosure in an amount smaller than the above-described range, a problem that it is not cured in an exposure environment with air may occur, and when the amine compound is contained in an amount larger than the above-described range, problems that the viscosity rises and the refractive index rises may occur.

The amine compound may specifically be a compound represented by Chemical Formula 18 below, but is not limited to the example below.

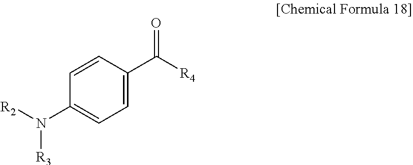

in Chemical Formula 18, R₂ and R₃ are each independently an alkyl group having 1 to 5 carbon atoms, and R₄ includes an alkyl group having 1 to 20 carbon atoms, an ether group having 1 to 20 carbon atoms, an aryl group having 6 to 30 carbon atoms, or an amine group, or is a (meth)acrylate group.

The amine compound may be, for example, one or more of ethyl dimethylamino benzoate, butoxyethyl dimethylamino benzoate, bis(diethylamino)benzophenone, bis(2-hydroethyl)-toluidine, ethylhexyl-(dimethylamino)benzoate, 2-(dimethylamino)ethyl (meth)acrylate, diethylaminoethyl (meth)acrylate, 2-(diisopropylamino)ethyl (meth)acrylate, 2-(acryloyloxy)ethyl 4-(dimethylamino)benzoate, 2-ethylhexyl 4-(dimethylamino)benzoate, ethyl 2-(dibutylamino)methyl acrylate, 4,4-(oxybis(ethane-2,1-diyl)) bis(oxy)bis(dimethylaniline), P115 (manufactured by SK Cytec), MIRAMER AS2010 (manufactured by Miwon Corporation), and MIRAMER AS5142 (manufactured by Miwon Corporation), but is not limited to the above examples.

The photocurable composition of the present disclosure may have an absolute viscosity of 5 cP to 50 cP at 25° C. More specifically, the photocurable composition may have an absolute viscosity of 5 cP to 30 cP at 25° C. The viscosity of the photocurable composition may be implemented by adjusting the weight ratio of each composition described above, and an additional solvent may be used if necessary. When the absolute viscosity of the photocurable composition is lower than the above-described range, a problem may occur in inkjet processability, and when the absolute viscosity is higher than the above-described range, a problem that inkjet and slit coatability are deteriorated may occur.

The photocurable composition of the present disclosure may be a solvent-free type. As described above, although a solvent for adjusting the viscosity may be included, since residual solvent may remain from the cured product according to the inclusion of the solvent, the composition may preferably be composed of a non-solvent type.

A cured product according to another embodiment of the present disclosure is a cured product in which the photocurable composition is cured, and the cured product may be cured on a substrate to form a coating layer having high transmittance characteristics, low haze characteristics, excellent adhesive force, and excellent heat resistance while exhibiting low refractive index characteristics.

The cured product may be a specifically patterned cured film, and may be, for example, a polyhedrally patterned cured film.

The cured product may have a refractive index of 1.48 or less with respect to the light having a wavelength of 450 nm.

The cured product may have a haze of 3% or less, and may have, specifically, a haze of 1.0% or less.

A display device according to another embodiment of the present disclosure includes the cured product. The display device may be, for example, an organic light emitting display device, and may include the cured product that is used for a light extraction layer. When the cured product is included as the light extraction layer, the light extraction performance of the display device can be improved together with the film exhibiting relatively high refractive properties so that a brighter display device can be realized under the same conditions.

### EXAMPLES

Hereinafter, the present disclosure will be described in more detail with Examples, but the present disclosure is not limited by the following Examples.

In order to simplify the notation of the following Examples, the notation of the first olefinic monomer indicated in the Tables of the following Examples is defined as in Table 1 below, and the notation of the second olefinic monomer is defined as in Table 2 below, and the notation of the photopolymerization initiator is defined as in Table 3 below, and the notation of the amine compound is defined as in Table 4 below.

TABLE 1

| Notation of first olefinic monomer | Chemical Formula | R₁ | n |
|---|---|---|---|
| 1 | 1 | H | — |
| 2 | | CH₃ | — |
| 3 | 2 | H | 1 |
| 4 | | H | 5 |
| 5 | | H | 10 |
| 6 | | CH₃ | 1 |
| 7 | | CH₃ | 5 |
| 8 | | CH₃ | 10 |
| 9 | 3 | H | — |
| 10 | | CH₃ | — |
| 11 | 4 | H | 1 |
| 12 | | H | 5 |
| 13 | | H | 10 |
| 14 | 5 | H | — |
| 15 | | CH₃ | — |
| 16 | 6 | H | 1 |
| 17 | | H | 5 |
| 18 | | H | 10 |
| 19 | 7 | H | — |
| 20 | | CH₃ | — |
| 21 | 8 | H | 1 |
| 22 | | H | 5 |
| 23 | | H | 10 |
| 24 | 9 | H | — |
| 25 | 10 | H | — |
| 26 | 11 | H | — |
| 27 | 12 | H | — |
| 28 | 13 | H | 1 |
| 29 | | H | 3 |
| 30 | | H | 6 |
| 31 | | H | 10 |
| 32 | 14 | H | — |
| 33 | 15 | H | — |
| 34 | 16 | H | — |
| 35 | 17 | H | — |

TABLE 2

| Notation of second olefinic monomer | Chemical name |
|---|---|
| 1 | Benzyl acrylate |
| 2 | Isodecyl acrylate |
| 3 | Lauryl acrylate |
| 4 | Ethoxyethyl acrylate |
| 5 | Vinyloxy ethoxyethyl acrylate |
| 6 | Dicyclopentenyl acrylate |
| 7 | Phenoxyethyl acrylate |
| 8 | Phenoxybenzyl acrylate |
| 9 | 1,6-Hexanediol diacrylate |
| 10 | Triethylene glycol di(meth)acrylate |
| 11 | Dicyclopentanyl acrylate |

TABLE 3

| Notation of | |
|---|---|
| photopolymerization | |
| initiator | Chemical name |
| 1 | 1-[9-ethyl-6-(2-methylbenzoyl)-9H-carbazoyl-3-yl]- |
| | 1-(O-acetyloxime) |
| 2 | OXE-01 (BASF) |
| 3 | OXE-02 (BASF) |
| 4 | OXE-04 (BASF) |
| 5 | Darocur TPO (BASF) |
| 6 | (E)-2-(acetoxyimino)-1-(9,9-diethyl-9H-fluorene-2- |
| | yl)butanone |
| 7 | Irgacure 819 |
| 8 | Irgacure 369 |
| 9 | Irgacure 907 |
| 10 | Triethylene glycol di(meth)acrylate |

TABLE 4

| Notation | |
|---|---|
| of amine | |
| compound | Chemical name |
| 1 | Ethyl dimethylamino benzoate |
| 2 | Butoxyethyl dimethylamino benzoate |
| 3 | Diethylaminoethyl acrylate |
| 4 | Bis(diethylamino)benzophenone |
| 5 | Bis(2-hydroethyl)-toluidine |
| 6 | Ethylhexyl-(dimethylamino)benzoate |
| 7 | P115 (manufactured by SK Cytec) |
| 8 | MIRAMER AS2010 (manufactured by Miwon Corporation) |
| 9 | MIRAMER AS5142 (manufactured by Miwon Corporation) |

### Preparation Example: Preparation of Photocurable Compositions

Photocurable compositions were prepared with the compositions of Table 5 below using the notations of Tables 1 to 4 above.

TABLE 5

| | Composition | | | | | | | |
|---|---|---|---|---|---|---|---|---|
| | First olefinic | | Second olefinic | | Photopolymerization | | Amine | |
| | monomer | | monomer | | initiator | | compound | |
| | | Content | | Content | | Content | | Content |
| | | (parts by | | (parts by | | (parts by | | (parts by |
| Classification | Type | weight) | Type | weight) | Type | weight) | Type | weight) |
| Example 1 | 2 | 90 | 1 | 10 | 1 | 10 | 1 | 5 |
| Example 2 | 2 | 80 | 1 | 20 | 1 | 10 | 1 | 5 |
| Example 3 | 2 | 70 | 1 | 30 | 1 | 10 | 1 | 5 |
| Example 4 | 2 | 60 | 1 | 40 | 1 | 10 | 1 | 5 |
| Example 5 | 2 | 50 | 1 | 50 | 1 | 10 | 1 | 5 |
| Example 6 | 2 | 45 | 1 | 55 | 1 | 10 | 1 | 5 |
| Comparative | 2 | 100 | 1 | 0 | 1 | 10 | 1 | 5 |
| Example 1 | | | | | | | | |
| Comparative | 2 | 0 | 1 | 100 | 1 | 10 | 1 | 5 |
| Example 2 | | | | | | | | |
| Example 7 | 15 | 50 | 2 | 50 | 1 | 1 | 1 | 5 |
| Example 8 | 15 | 50 | 2 | 50 | 1 | 10 | 1 | 5 |
| Example 9 | 15 | 50 | 2 | 50 | 1 | 15 | 1 | 5 |
| Example 10 | 15 | 50 | 2 | 50 | 1 | 20 | 1 | 5 |
| Comparative | 15 | 50 | 2 | 50 | 1 | 21 | 1 | 5 |
| Example 3 | | | | | | | | |
| Comparative | 15 | 50 | 2 | 50 | 1 | 0.5 | 1 | 5 |
| Example 4 | | | | | | | | |
| Example 11 | 25 | 50 | 8 | 50 | 1 | 10 | 4 | 1 |
| Example 12 | 25 | 50 | 8 | 50 | 1 | 10 | 4 | 10 |
| Example 13 | 25 | 50 | 8 | 50 | 1 | 10 | 4 | 15 |
| Comparative | 25 | 50 | 8 | 50 | 1 | 10 | 4 | 0.5 |
| Example 5 | | | | | | | | |
| Comparative | 25 | 50 | 8 | 50 | 1 | 10 | 4 | 16 |
| Example 6 | | | | | | | | |
| Example 14 | 30 | 50 | 7 | 40 | 9 | 10 | 6 | 5 |
| | 1 | 10 | | | | | | |
| Example 15 | 30 | 80 | 7 | 10 | 9 | 10 | 6 | 5 |
| | 1 | 10 | | | | | | |
| Example 16 | 30 | 90 | 7 | 5 | 9 | 10 | 6 | 5 |
| | 1 | 5 | | | | | | |
| Example 17 | 2 | 95 | 1 | 5 | 1 | 10 | 1 | 5 |
| Reference | Pentafluorophenyl | 50 | 1 | 50 | 1 | 10 | 1 | 5 |
| Example 1 | acrylate | | | | | | | |

### Experimental Example: Evaluation of Physical Properties of Photocurable Compositions

Optical films were prepared by photocuring the photocurable compositions for Examples and Comparative Examples prepared according to the Preparation Example, and respective physical properties were measured by the methods as described below and are shown in Table 7 below.
1) Refractive index

For the above-described optical films, the refractive indexes (average λ: 450±20 nm) were measured using an ellipsometer.
Evaluation rubric
⊚: When the refractive index of the optical film is 1.46 or less
◯: When the refractive index measurement value of the optical film is more than 1.46 to 1.48

Δ: When the refractive index measurement value of the optical film is more than 1.48 to 1.49
X: When the refractive index measurement value of the optical film is more than 1.49
2) Transmittance

For the optical films, average transmittances at λ=450±20 nm were measured using a UV-VIS spectrophotometer (Cary4000, Agilent).
Evaluation rubric
◯: When the average transmittance value is 90% or more
X: When the average transmittance value is less than 90%
3) Haze

Haze was measured using a haze meter COH 400 manufactured by NIPPON DENSHOKU.
Evaluation rubric
⊚: When the haze measurement value is 1.0 or less
◯: When the haze measurement value is more than 1.0 to 3.0 or less
Δ: When the haze measurement value is more than 3.0 to 4.0 or less
X: When the haze measurement value is more than 4.0
4) Viscosity (absolute viscosity)

Respective absolute viscosities were measured on the respective photopolymerizable compositions and olefinic monomers of the above-described Comparative Examples and Examples at a temperature of 25° C. using a viscometer (trade name: Brook Field viscometer).
Evaluation rubric
⊚: When the absolute viscosity value is 5 to 20 cP
◯: When the absolute viscosity value is 21 to 30 cP
Δ: When the absolute viscosity value is 31 to 50 cP
X: When the absolute viscosity value is out of the above-described range
5) Inkjet processability

It was confirmed whether surface formation was possible while changing the nozzle temperature of the inkjet equipment.
Evaluation rubric
◯: Surface formation at a nozzle temperature of 25 to 50° C.
X: No surface formation (Uncoating) at a nozzle temperature 25 to 50° C.
6) Slit coatability

Coatability was confirmed using slit coater equipment.
Evaluation rubric
◯: Surface formation; X; No surface formation (Uncoating)
7) Bottom adhesiveness

100 cells were cross-cut at 1 mm² intervals on the cured film formed on the lower SiOₓ film, and adhesive forces thereof with that of the lower SiOₓ film were compared using a tape.

They were expressed as 0 to 5B according to the level of adhesive force.

TABLE 6
Classification of Adhesion Test Results

| Classification | Percent Area Removed |
|---|---|
| 5B | 0% None |
| 4B | Less Than 5% |
| 3B | 5-15% |
| 2B | 15-35% |
| 1B | 35-65% |
| 0B | Greater Than 65% |

8) Top adhesiveness

For the optical films, a SiOₓ film of 0.2 μm was further deposited via a CVD process. 100 cells were cross-cut at 1 mm² intervals on the upper SiOₓ, and adhesive forces thereof with that of the lower low refractive index optical film were compared using a tape.

They were expressed as 0 to 5B according to the level of adhesion.

TABLE 7

| | Refractive | | | | Inkjet | Slit | Bottom | Top |
|---|---|---|---|---|---|---|---|---|
| | index | Transmittance | Haze | Viscosity | processability | coatability | adhesiveness | adhesiveness |
| Example 1 | ◯ | ◯ | ◯ | ◯ | ◯ | ◯ | 5B | 5B |
| Example 2 | ◯ | ◯ | ◯ | ◯ | ◯ | ◯ | 5B | 5B |
| Example 3 | ◯ | ◯ | ◯ | ◯ | ◯ | ◯ | 5B | 5B |
| Example 4 | ◯ | ◯ | ◯ | ◯ | ◯ | ◯ | 5B | 5B |
| Example 5 | ◯ | ◯ | ◯ | ◯ | ◯ | ◯ | 5B | 5B |
| Example 6 | Δ | ◯ | ◯ | ◯ | ◯ | ◯ | 5B | 5B |
| Comparative | ◯ | ◯ | ◯ | X | X | ◯ | 3B | 3B |
| Example 1 | | | | | | | | |
| Comparative | X | ◯ | ◯ | ◯ | ◯ | ◯ | 5B | 5B |
| Example 2 | | | | | | | | |
| Example 7 | ◯ | ◯ | ◯ | ◯ | ◯ | ◯ | 5B | 5B |
| Example 8 | ◯ | ◯ | ◯ | ◯ | ◯ | ◯ | 5B | 5B |
| Example 9 | ◯ | ◯ | ◯ | ◯ | ◯ | ◯ | 5B | 5B |
| Example 10 | ◯ | ◯ | ◯ | ◯ | ◯ | ◯ | 5B | 5B |
| Comparative | Unable to measure due to precipitation of initiator | | | | | | | |
| Example 3 | | | | | | | | |
| Comparative | X | ◯ | ◯ | ◯ | X | X | 3B | 3B |
| Example 4 | | | | | | | | |
| Example 11 | ◯ | ◯ | ◯ | ◯ | ◯ | ◯ | 5B | 5B |
| Example 12 | ◯ | ◯ | ◯ | ◯ | ◯ | ◯ | 5B | 5B |
| Example 13 | ◯ | ◯ | ◯ | ◯ | ◯ | ◯ | 5B | 5B |
| Comparative | ◯ | X | X | ◯ | ◯ | ◯ | 5B | 5B |
| Example 5 | | | | | | | | |
| Comparative | X | ◯ | ◯ | X | X | X | 5B | 5B |
| Example 6 | | | | | | | | |
| Example 14 | ⊚ | ◯ | ◯ | ⊚ | ◯ | ◯ | 5B | 5B |
| Example 15 | ◯ | ◯ | ◯ | ◯ | ◯ | ◯ | 5B | 5B |
| Example 16 | ◯ | ◯ | ◯ | Δ | ◯ | ◯ | 4B | 4B |
| Example 17 | ◯ | ◯ | ◯ | Δ | ◯ | ◯ | 4B | 4B |
| Reference | ◯ | ◯ | Δ | Δ | ◯ | ◯ | 4B | 4B |
| Example 1 | | | | | | | | |

As in the results of Table 7 shown above, it can be seen that not only low refractive index characteristics can be exhibited, but also inkjet and slit coatability are excellent according as using the fluorine-based olefin monomer and the olefin monomer having a specific absolute viscosity value together in the present disclosure. In addition, it can be seen that optical properties such as transmittance and haze are particularly excellent when an amine compound is included.

Meanwhile, when the first or second monomer is used alone, it can be seen that the desired optical properties or processability are not implemented, and furthermore, even when the photoinitiator or amine compound is not contained in a particular content range, it can be seen that the desired properties are not implemented similarly.

Although the exemplary embodiments of the present disclosure have been described in detail above, the scope of the present disclosure is not limited thereto, and various modifications and improved forms apparent to those skilled in the art using the basic concept of the present disclosure defined in the following claims also fall within the scope of the present disclosure.

1. A photocurable composition comprising:
a first olefinic monomer containing fluorine;
a second olefinic monomer having an absolute viscosity of 7 cP or less at 25° C.;
1 to 20 parts by weight of a photopolymerization initiator based on 100 parts by weight of the total weight of the first and the second olefinic monomers; and
1 to 15 parts by weight of an amine compound based on 100 parts by weight of the total weight of the first and the second olefinic monomers.

2. The photocurable composition of claim 1, wherein the homopolymer of the first olefinic monomer has a refractive index of 1.46 or less with respect to light of a wavelength of 450 nm.

3. The photocurable composition of claim 1, wherein the first olefinic monomer has an absolute viscosity of 50 cP or less at 25° C.

4. The photocurable composition of claim 1, wherein the first olefinic monomer includes a structure of the following General Formula 1:
(A)ₒ-(Z)ᵣ-(CFX)ₙ(R_{f})ₘ-(Z)ₛ-(A)ₚ [General Formula 1]
wherein, in General Formula 1,
A is a curable functional group,
o and p are each independently an integer of 0 or 1 (provided that o and p are not 0 at the same time),
r and s are each independently an integer of 0 or 1 (provided that r and s are not 0 at the same time),
Z is a divalent organic group having 1 to 10 carbon atoms,
X is a hydrogen atom, a fluorine atom, or a trifluoromethyl(ene) group,
n is an integer of 0 to 20,
R_{f} is hydrogen, a fluoroalkyl group or fluoroalkylene group having 1 to 20 carbon atoms which includes an etheric oxygen atom, —OF group, or a fluorine atom,
m is an integer of 0 to 2, and
n and m are not 0 at the same time.

5. The photocurable composition of claim 4, wherein the first olefinic monomer includes a fluoroalkyl(ene) group.

6. The photocurable composition of claim 5, wherein the first olefinic monomer includes a diacrylate-based monomer and a monoacrylate-based monomer.

7. The photocurable composition of claim 6, wherein the amount of the diacrylate-based monomer is greater than the amount of the monoacrylate-based monomer.

8. The photocurable composition of claim 4, wherein the first olefinic monomer includes one or more of the monomers represented by the following Chemical Formulas 1 to 17: 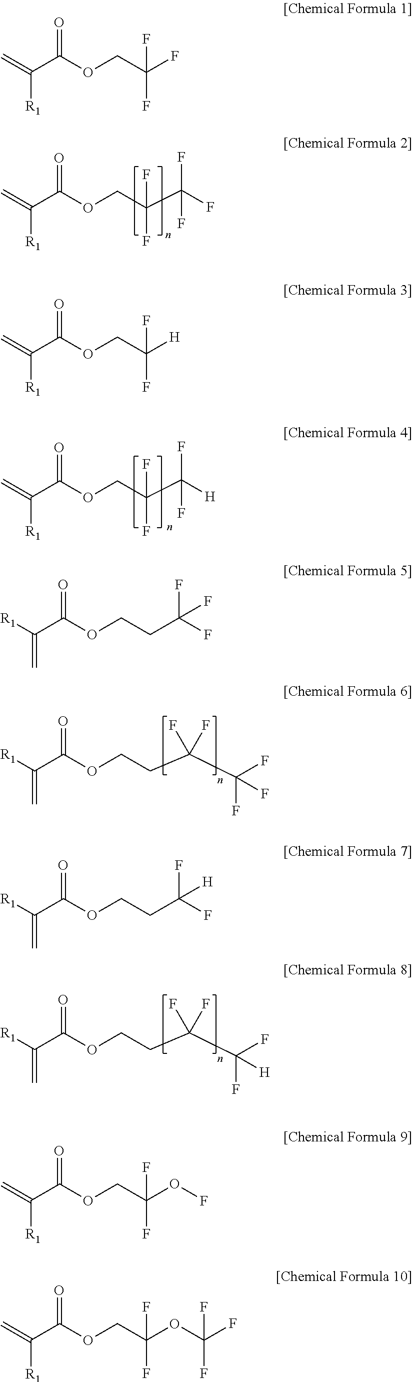 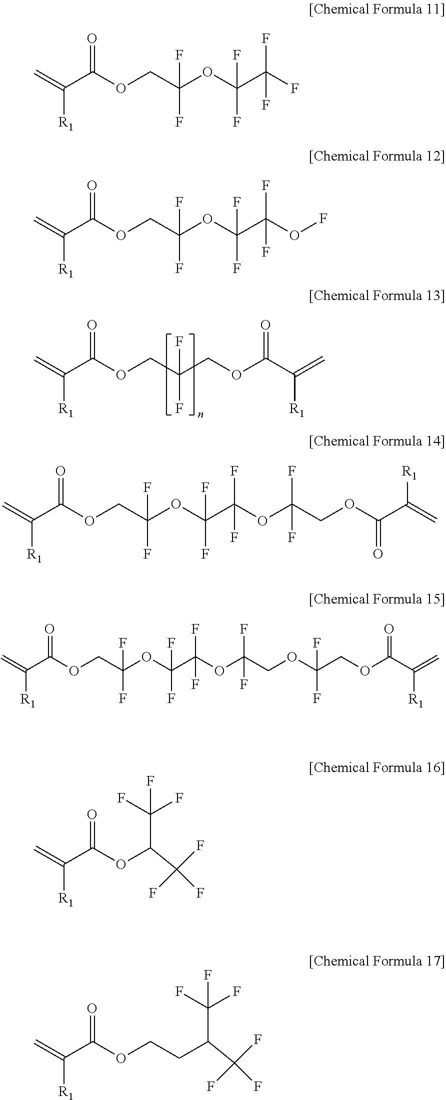
wherein, in Chemical Formulas 2, 4, 5, 8, and 13, n's are each independently an integer of 1 to 10, and in Chemical Formulas 1 to 17, R₁'s are each independently hydrogen or a methyl group.

9. The photocurable composition of claim 1, wherein the second olefinic monomer has a refractive index of the homopolymer of 1.56 or less with respect to light of 450 nm wavelength.

10. The photocurable composition of claim 1, wherein the second olefinic monomer includes one or more selected from the group consisting of benzyl (meth)acrylate, isodecyl (meth)acrylate, lauryl (meth)acrylate, ethoxy ethyl (meth)acrylate, vinyloxyethoxyethyl (meth)acrylate, dicyclopentenyl (meth)acrylate, phenoxy ethyl (meth)acrylate, phenoxy benzyl (meth)acrylate, 1,6-hexanediol di(meth)acrylate, triethylene glycol di(meth)acrylate, and dicyclopentanyl (meth)acrylate.

11. The photocurable composition of claim 1, wherein the amine compound contains one or more of a curable functional group or an aromatic structure that has an etheric oxygen atom or a carbonyl group.

12. The photocurable composition of claim 11, wherein the amine compound is one represented by the following Chemical Formula 18: 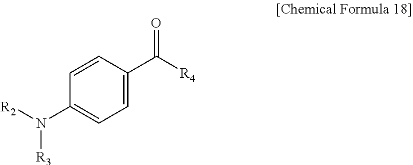
wherein, in Chemical Formula 18, R₂ and R₃ are each independently an alkyl group having 1 to 5 carbon atoms, and R₄ includes an alkyl group having 1 to 20 carbon atoms, an ether group having 1 to 20 carbon atoms, an aryl group having 6 to 30 carbon atoms, or an amine group, or is a (meth)acrylate group.

13. The photocurable composition of claim 11, wherein the amine compound includes one or more selected from the group consisting of ethyl dimethylamino benzoate, butoxyethyl dimethylamino benzoate, bis(diethylamino)benzophenone, bis(2-hydroethyl)-toluidine, ethylhexyl-(dimethylamino)benzoate, 2-(dimethylamino)ethyl (meth)acrylate, diethylaminoethyl (meth)acrylate, 2-(diisopropylamino)ethyl (meth)acrylate, 2-(acryloyloxy)ethyl 4-(dimethylamino)benzoate, 2-ethylhexyl 4-(dimethylamino)benzoate, ethyl 2-(dibutylamino)methyl acrylate, and 4,4-(oxybis(ethane-2,1-diyl)) bis(oxy)bis(dimethylaniline).

14. The photocurable composition of claim 1, wherein an absolute viscosity of the photocurable composition is 5 cP to 50 cP at 25° C.

15. The photocurable composition of claim 1, wherein the first olefinic monomer and the second olefinic monomer have a weight ratio of 50:50 to 90:10.

16. The photocurable composition of claim 1, wherein the photocurable composition is a solvent-free type.

17. A cured product obtained by curing the photocurable composition of claim 1.

18. The cured product of claim 17, wherein the cured product has a refractive index of 1.48 or less with respect to light having a wavelength of 450 nm, and has a haze of 3% or less.

19. A display device comprising the cured product of claim 17.
